(19) United States
(12) Patent Application Publication
(10) Pub. No.: US 2024/0211676 A1
(43) Pub. Date: Jun. 27, 2024

(54) SYSTEMS AND METHODS FOR ARTIFICIAL INTELLIGENCE ASSISTED ANTENNA DESIGN

(71) Applicant: Meta Platforms Technologies, LLC, Menlo Park, CA (US)

(72) Inventors: Weiping Dou, Cupertino, CA (US); Ulf Jan Ove Mattsson, Campbell, CA (US); Peter Eli Renner, San Jose, CA (US); Jiang Zhu, Cupertino, CA (US); Geng Ye, Union City, CA (US); Yuandong Tian, San Carlos, CA (US); Andrew Cohen, San Francisco, CA (US); Beidi Chen, Pittsburgh, PA (US)

(21) Appl. No.: 18/393,216

(22) Filed: Dec. 21, 2023

Related U.S. Application Data
(60) Provisional application No. 63/435,123, filed on Dec. 23, 2022.

(51) Int. Cl. G06F 30/398; G06F 30/31

(52) U.S. Cl. CPC G06F 30/398; G06F 30/31; G06F 2119/18

(57) ABSTRACT

A disclosed computer-implemented method may include (1) receiving (A) a set of design specifications associated with an antenna performance characteristic, (B) a set of requirements for an antenna architecture, (C) a parameterization that describes parameters of an antenna structure, and (D) a set of bounds for the parameterization, and (2) determining, based on the set of design specifications, the set of requirements, the parameterization, and the set of bounds, and in accordance with a global optimization algorithm and a local tuning algorithm, a design for the antenna architecture. Various other methods, systems, and computer-readable media are also disclosed.

### CROSS-REFERENCE TO RELATED APPLICATION

This application claims the benefit of U.S. Provisional Patent Application No. 63/435,123, filed Dec. 23, 2022, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for artificial intelligence assisted antenna design.

FIG. 2 is a block diagram of an example implementation of a system for artificial intelligence assisted antenna design.

FIG. 3 is a flow diagram of an example method for artificial intelligence assisted antenna design.

FIG. 4A, FIG. 4B, FIG. 4C, FIG. 5A, FIG. 5B, FIG. 6A, FIG. 6B, FIG. 6C, and FIG. 6D show various views of antenna parameterizations that may comply with prerequisites described herein.

FIG. 7 illustrates antenna geometries that may be generated in accordance with some of the systems and methods disclosed herein.

FIG. 8 shows a flow diagram that may broadly describe a process for determining an antenna design in accordance with the systems and methods described herein.

FIG. 9 illustrates an operational flow diagram of an evolutionary algorithm used in antenna design in some examples described herein.

FIG. 10 shows an algorithm for determining a mutation rate in accordance with some systems and methods described herein.

FIG. 11 provides an outline of a trust-region gradient-based algorithm with numerical derivatives in accordance with some embodiments of the systems and methods described herein.

FIG. 12 shows an additional flow diagram that illustrates a method for artificial intelligence assisted antenna design in accordance with some of the systems and methods described herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Design of modern antenna structures may be a challenging endeavor. It may be laborious and heavily reliant on engineering insight and experience, especially at the initial stages oriented towards the development of a suitable antenna architecture. Typical antenna development may require weeks of human expert involvement due to the interactive nature of such development. Additionally, some hands-on procedures involved in antenna design, such as parametric studies, for validating suitability of particular geometric setups, may further increase this challenge. Similar reasons may apply to allow a designer to investigate or try out only a very limited number of antenna geometry arrangements. Hence, the present disclosure identifies and addresses a need for additional and/or improved systems and methods for antenna topology design and development.

The present disclosure, including the accompanying appendices, is generally directed to systems and methods for unsupervised specification-driven design of planar antennas. Examples of the systems and methods described herein may capitalize on a flexible and scalable antenna parameterization, which may enable realization of complex antenna geometries while maintaining reasonably small parameter space dimensionality. Some embodiments may employ a customized nature-inspired algorithm to carry out space exploration and identification of a quasi-optimum antenna topology in a global sense. Some embodiments may further incorporate a fast gradient-based procedure to fine-tune antenna dimensions.

Some embodiments of the systems and methods described in this disclosure may work entirely in a black-box fashion, with the only input being design specifications and optional constraints (e.g., a structure size). Embodiments of this disclosure may demonstrate the capability of the presented technique to generate unconventional antenna topologies of satisfactory performance using reasonable computational budgets, and with no human expert interaction necessary whatsoever.

Some technical contributions of this this disclosure may include, without limitation, (i) a flexible and scalable parameterization of antenna structures, suitable for both combinatorial and continuous optimization, (ii) encapsulating tools for antenna topology alteration and dimension adjustment within the same parameterization described by a reasonably small number of variables, (iii) an algorithmic framework for unsupervised (specification-driven) antenna design, (iv) a demonstration of practical utility of the framework using several examples of antennas designed under challenging scenarios (e.g., dual- and triple-band specifications, limited footprint, accounting for antenna environment, and so forth).

One aspect of the approach disclosed herein for unsupervised development of planar antennas may be a scalable antenna parameterization, which may allow for generation and processing of complex geometries while maintaining reasonably low parameter space dimensionality. The latter may improve efficiency of processing of antenna topologies and dimension sizing using numerical optimization techniques.

As will be described in greater detail below, embodiments of the instant disclosure may receive various data and/or parameters, such as a set of design specifications associated with an antenna performance characteristic, a set of requirements for an antenna architecture, a parameterization that describes parameters of an antenna structure, and/or a set of bounds for the parameterization. Some embodiments may further determine, based on the set of design specifications, the set of requirements, the parameterization, and the set of bounds, and in accordance with a global optimization algorithm and a local tuning algorithm, a design for the antenna architecture.

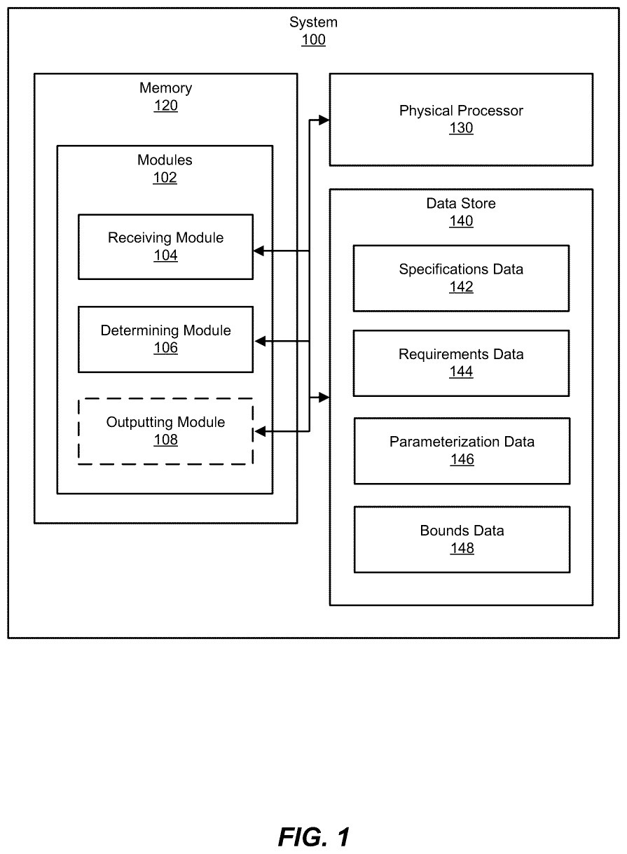

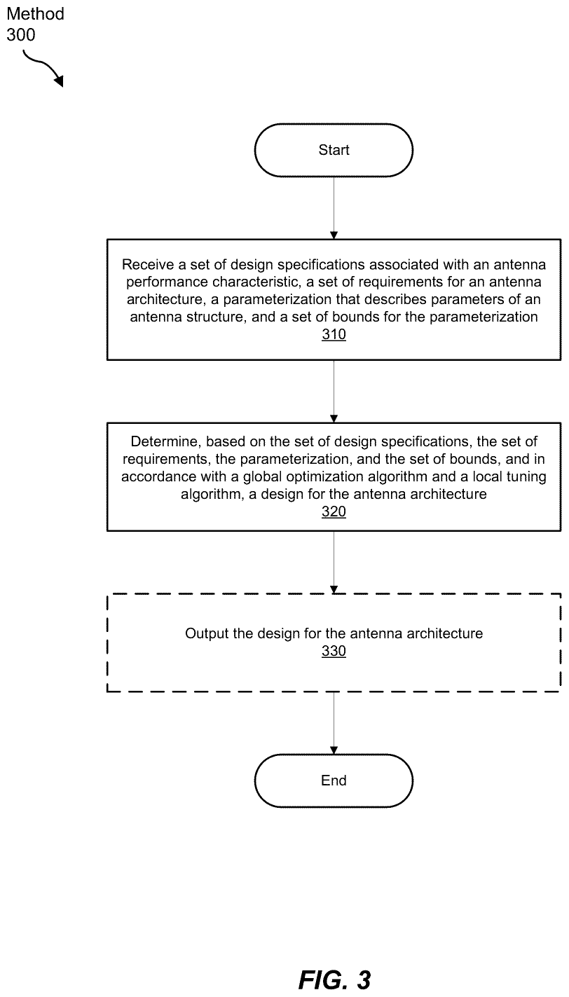

The following will describe, with reference to FIG. 1 to FIG. 2 and FIG. 3 to FIG. 12, various systems for artificial intelligence assisted antenna design. In addition, various methods for artificial intelligence assisted antenna design will be described below in reference to FIG. 3.

FIG. 1 is a block diagram of an example system 100 for artificial intelligence assisted antenna design. As illustrated in this figure, example system 100 may include one or more modules 102 for performing one or more tasks. As will be explained in greater detail below, modules 102 may include a receiving module 104 that receives a set of design specifications associated with an antenna performance characteristic, a set of requirements for an antenna architecture, a parameterization that describes parameters of an antenna structure, and a set of bounds for the parameterization. Additionally, modules 102 may include a determining module 106 that determines, based on the set of design specifications, the set of requirements, the parameterization, and the set of bounds, and in accordance with a global optimization algorithm and a local tuning algorithm, a design for the antenna architecture. In some additional or alternative examples, modules 102 may additionally include an outputting module 108 that outputs the design for the antenna architecture. Note that, as indicated by the dashed lines of outputting module 108, outputting module 108 may be optional and/or may not be included in all implementations.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate artificial intelligence assisted antenna design. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, etc.). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

Data store 140 may include, maintain, store, etc. various types and/or forms of data that one or more of modules 102 may access, alter, transform, interact with, maintain, store, and so forth to perform one or more tasks. For example, as shown in FIG. 1, data store 140 may include specifications data 142, requirements data 144, parameterization data 146, and bounds data 148. In general, specifications data 142 includes detailed performance characteristics required for the antenna design, such as frequency range, gain, impedance, radiation pattern, and power handling capabilities, reflecting the operational environment and the expected functionality of the antenna. Requirements data 144 may include physical and regulatory constraints for an antenna architecture, like size, shape, material specifications, weight limitations, compliance with industry standards, and environmental conditions under which the antenna must operate.

Parameterization data 146 may encompass variables and their possible values that may define the antenna structure, which may include, but are not limited to, the length, width, height, curvature of elements, and dielectric properties. It may represent the adjustable aspects of the antenna's geometry that can be manipulated during the design process. Finally, bounds data 148 may include or represent limits within which a parameterization can vary, serving as constraints for the optimization algorithms. They may ensure the design stays within feasible and practical ranges, such as minimum and maximum dimensions, permissible material properties, and regulatory compliance margins.

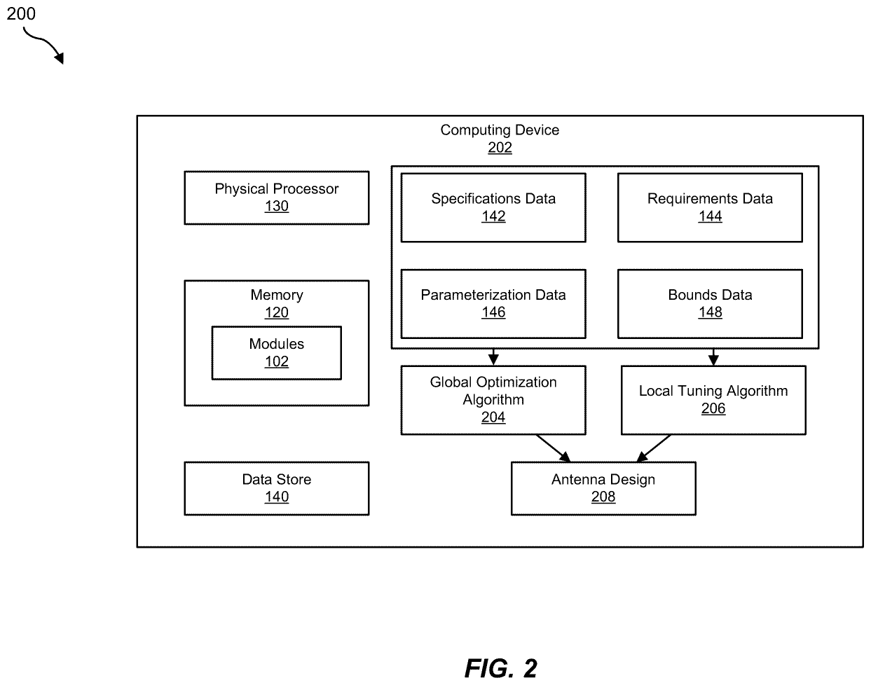

Example system 100 in FIG. 1 may be implemented in a variety of ways. For example, all or a portion of example system 100 may represent portions of an example system 200 (“system 200”) in FIG. 2. As shown in FIG. 2, system 200 may include a computing device 202. In at least one example, computing device 202 may be programmed with one or more of modules 102.

In at least one embodiment, one or more modules 102 from FIG. 1 may, when executed by computing device 202, enable computing device 202 to perform one or more operations for artificial intelligence assisted antenna design. For example, as will be described in greater detail below, receiving module 104 may cause computing device 202 to receive a set of design specifications associated with an antenna performance characteristic (e.g., specifications data 142), a set of requirements for an antenna architecture (e.g., requirements data 144), a parameterization that describes parameters of an antenna structure (e.g., parameterization data 146), and a set of bounds for the parameterization (e.g., bounds data 148).

Likewise, determining module 106 may cause computing device 202 to determine, based on the set of design specifications, the set of requirements, the parameterization, and the set of bounds, and in accordance with a global optimization algorithm (e.g., global optimization algorithm 204) and a local tuning algorithm (e.g., local tuning algorithm 206), a design for the antenna architecture (e.g., antenna design 208). Moreover, in some examples, outputting module 108 may cause computing device 202 to output the antenna design.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to execute one or more operations for artificial intelligence assisted antenna design.

Many other devices or subsystems may be connected to system 100 in FIG. 1 and/or system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example computer-implemented method 300 for artificial intelligence assisted antenna design. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may receive a set of design specifications associated with an antenna performance characteristic, a set of requirements for an antenna architecture, a parameterization that describes parameters of an antenna structure, and a set of bounds for the parameterization. For example, receiving module 104 may, as part of computing device 202, cause computing device 202 to receive (e.g., from data store 140 and/or from a user via a user interface) specifications data 142, requirements data 144, parameterization data 146, and bounds data 148.

Receiving module 104 may cause computing device 202 to receive the above data in a variety of contexts. For example, as indicated in FIG. 1 and FIG. 2, the above data may be included in (e.g., stored by, maintained by, received into, etc.) data store 140. Hence, receiving module 104 may access data store 140 to receive the above data. In additional or alternative embodiments, receiving module 104 may receive the above data from a user via any suitable user interface and/or via any suitable data storage, communication, and/or transmission medium.

Antenna parameterization may be developed based on some prerequisites. For example, parameterization should provide sufficient flexibility to mimic the shapes of popular types of microstrip antennas (e.g., monopoles, patch antennas, dipoles, etc.). Antenna parameterization may contain continuous parameters (e.g., metallization patch sizes and location) to facilitate local tuning. Additionally, antenna parameterization may include discrete parameters to adjust the structure complexity. Furthermore, antenna parameterization may be scalable so as to enable changing the number of antenna components, and, consequently, the number of adjustable parameters. This scalability may be preferred over parameterizations featuring fixed numbers of antenna components. Finally, parameterization should be easy to implement, handle, and extend, in an electromagnetic (EM) simulation environment.

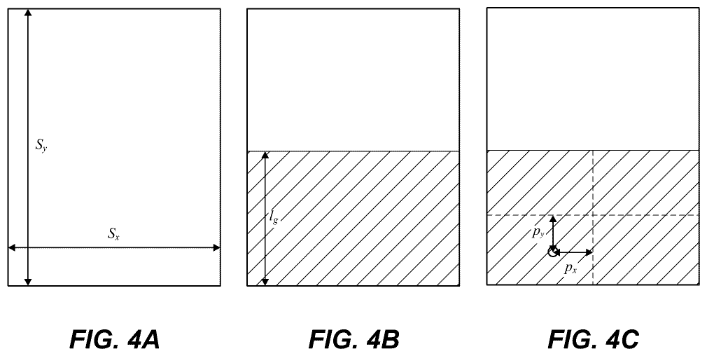

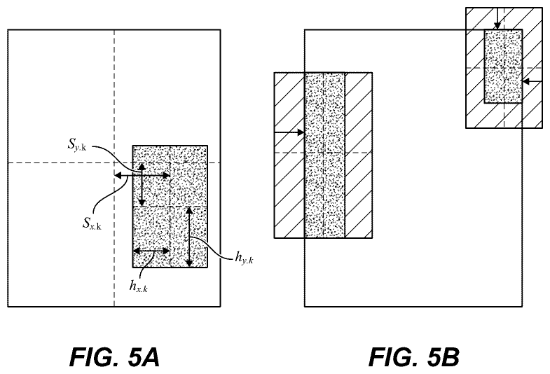

An example parameterization complying with the aforementioned prerequisites is illustrated in FIGS. 4A through 5C and may include (note: horizontal and vertical dimensions are marked using the subscript x and y, respectively):

Substrate: A substrate is assumed to be rectangular, of the size Sₓ and S_{y}, as shown in FIG. 4A. The substrate thickness is h, and its dielectric permittivity is ∈ᵣ. Both may be fixed or variable, depending on the design's and/or designer's needs.

Ground plane: A ground plane is depicted as a solid rectangle extending through the entire substrate in the x direction and l_{g} in the y direction, as shown in FIG. 4B.

Discrete port: A port location is pₓ and p_{y} with regard to the center of a specified metallization patch. The port to the ground plane, and one of the metallization patches on the front side, as shown in FIG. 4C.

Front-side metallic patches: The antenna may contain N_{P} metallic patches, the centers of which can freely move within the substrate area. Each patch may be parameterized using four parameters: Center of the k-th patch: s_{x.k} (horizontal coordinate), s_{y.k} (vertical coordinate); and size of the k-th patch: h_{x.k} (horizontal coordinate), h_{y.k} (vertical coordinate) for k=1, . . . , N_{P}. The patch center is allocated with regard to the center of the substrate, as shown in FIG. 5A. Further, the patches are trimmed as necessary to ensure that they do not extend beyond the substrate outline.

In some examples, patch trimming may be realized using the following formulas, as illustrated by FIG. 5B:

$$\\ {h}_{x . k} = min ( {h}_{x . k} , {d}_{x . k} ) , where {d}_{x . k} = \frac{{S}_{x}}{2} - \vert {S}_{x . k} \vert$$

$$\\ {h}_{y . k} = min ( {h}_{y . k} , {d}_{y . k} ) , where {d}_{y . k} = \frac{{S}_{y}}{2} - \vert {S}_{y . k} \vert$$

The patches may be concatenated in a Boolean sense to form the front metallization of the antenna structure.

Front-side holes: The antenna may contain N_{H} holes, which may be understood as the areas with removed metallization. As for the patches, the centers of the hole can move freely. Each hole may be parameterized using four parameters:
Center of the k-th hole: h_{x.k} (horizontal coordinate), h_{y.k} (vertical coordinate); and
Size of the k-th hole: h_{hx.k} (horizontal coordinate), h_{hy.k} (vertical coordinate) for k=1, . . . , N_{H}. The hole center may be allocated with respect to the center of the substrate, as shown in FIG. 6A. The holes are subtracted from front-side metallization in a Boolean sense, as shown in FIG. 6A, FIG. 6B, FIG. 6C, and FIG. 6D.

All antenna parameters, including dimensions of the substrate, port location, location and sizes of the patches and holes are gathered into a parameter vector x to be processed by the optimization algorithms, both global and local.

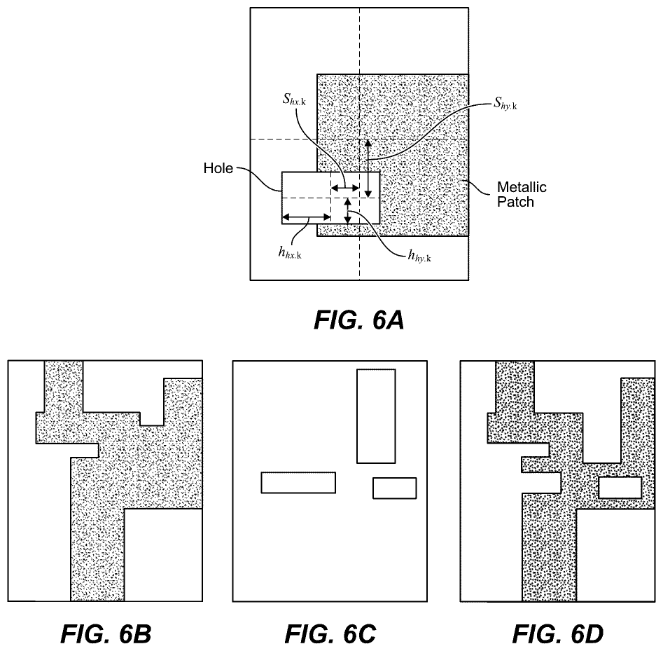

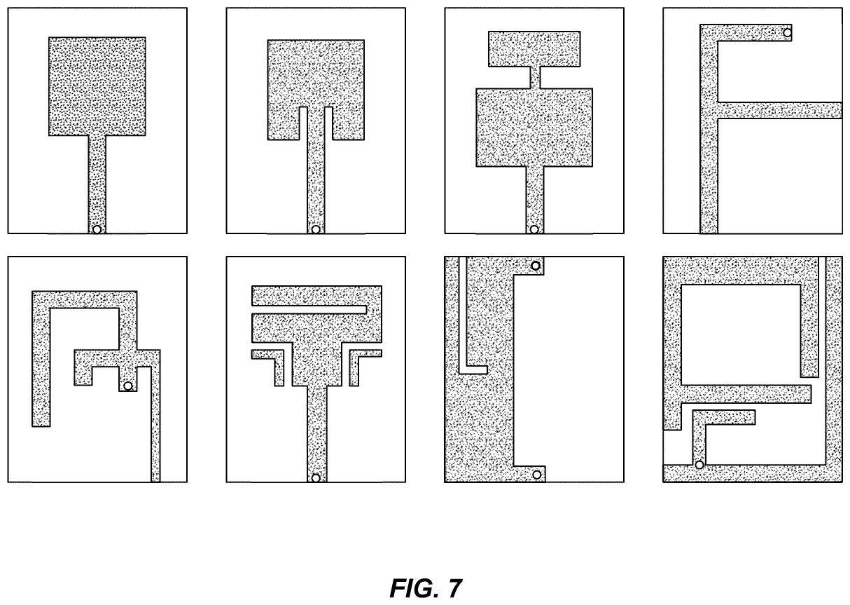

The disclosed parameterization technique enables the generation of a wide array of antenna geometries, illustrated by way of example in FIG. 7. These geometries, potentially unconventional and optimized beyond standard engineering designs, are formed through adjustable metallic patch and hole sizes. This allows for global and local changes to the antenna's geometry without additional elements. The complexity and size of the antenna, as well as the count of constituent building blocks, can be dynamically altered during the design process without changing the parameter space's dimensionality. Unlike mesh-based parameterization, this method's reliance on continuous variables facilitates compatibility with local optimization algorithms, including gradient and stencil-based methods.

At step 320, one or more of the systems described herein may determine, based on the set of design specifications, the set of requirements, the parameterization, and the set of bounds, and in accordance with a global optimization algorithm and a local tuning algorithm, a design for the antenna architecture. For example, determining module 106 may, as part of computing device 202, cause computing device 202 to determine, based on specifications data 142, requirements data 144, parameterization data 146, and bounds data 148, and in accordance with global optimization algorithm 204 and local tuning algorithm 206, antenna design 208.

In some examples, a global optimization algorithm (e.g., global optimization algorithm 204) may be any algorithm designed to search for an optimal or near-optimal antenna design solution over an entire design space defined by the parameterization data. It may be responsible for identifying a global optimum by exploring various antenna geometries, potentially without being trapped in local optima. This could involve algorithms like genetic algorithms, which simulate the process of natural selection to evolve better antenna designs over successive generations.

Moreover, in some examples, after a promising antenna design is identified by the global optimization algorithm, a local tuning algorithm (e.g., local tuning algorithm 206) may fine-tune the design. This algorithm may make smaller, more precise adjustments to the antenna parameters to enhance performance characteristics such as impedance matching, gain, or bandwidth. Techniques could include, without limitation, gradient descent or simulated annealing, which may refine the design by making iterative improvements within a local region of the design space.

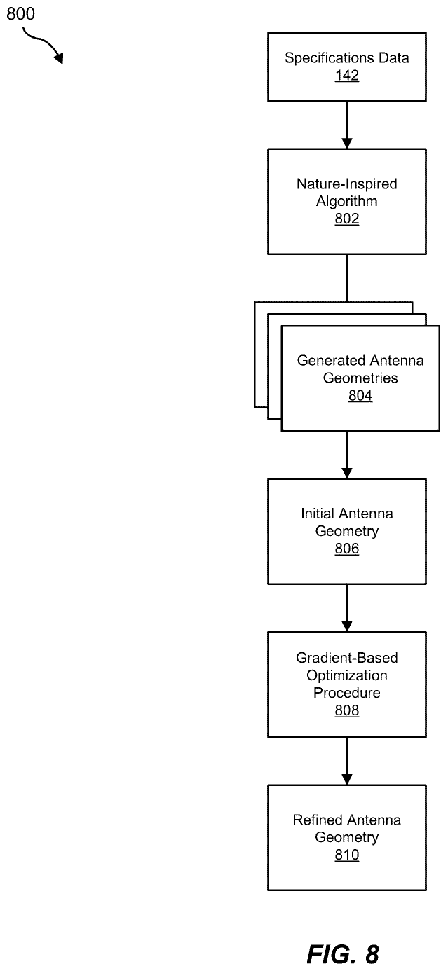

FIG. 8 shows a flow diagram 800 that may broadly describe a process whereby determining module 106 may determine antenna design 208. As shown, in some examples, determining module 106 may determine the design for the antenna architecture by using a nature-inspired algorithm within a scalable antenna parameterization framework. As shown in FIG. 8, determining module 106 may, based on specifications data 142 and in accordance with nature-inspired algorithm 802, automatically generate a plurality of generated antenna geometries 804. Determining module 106 may then select an initial antenna geometry 806 from the plurality of generated geometries, and may refine the selected antenna geometry by applying a gradient-based optimization procedure 808 to fine-tune antenna dimensions (i.e., generate refined antenna geometry 810). One or more of modules 102 (e.g., determining module 106 and/or outputting module 108) may then output the refined antenna geometry.

In some examples, determining module 106 may automatically generate plurality of generated antenna geometries 804 by initializing a population of antenna designs within the scalable antenna parameterization framework based on the set of design specifications. Determining module 106 may then execute an iterative process for evolving the antenna designs using the nature-inspired algorithm. This iterative process may include evaluating the performance of each antenna design against the set of design specifications, selecting a superior antenna design based on a performance evaluation, and generating a new antenna design by applying variation operators within the bounds of the parameterization. Determining module 106 may repeat the iterative process until a predetermined criterion is met, resulting in a diverse set of optimized antenna geometries for selection.

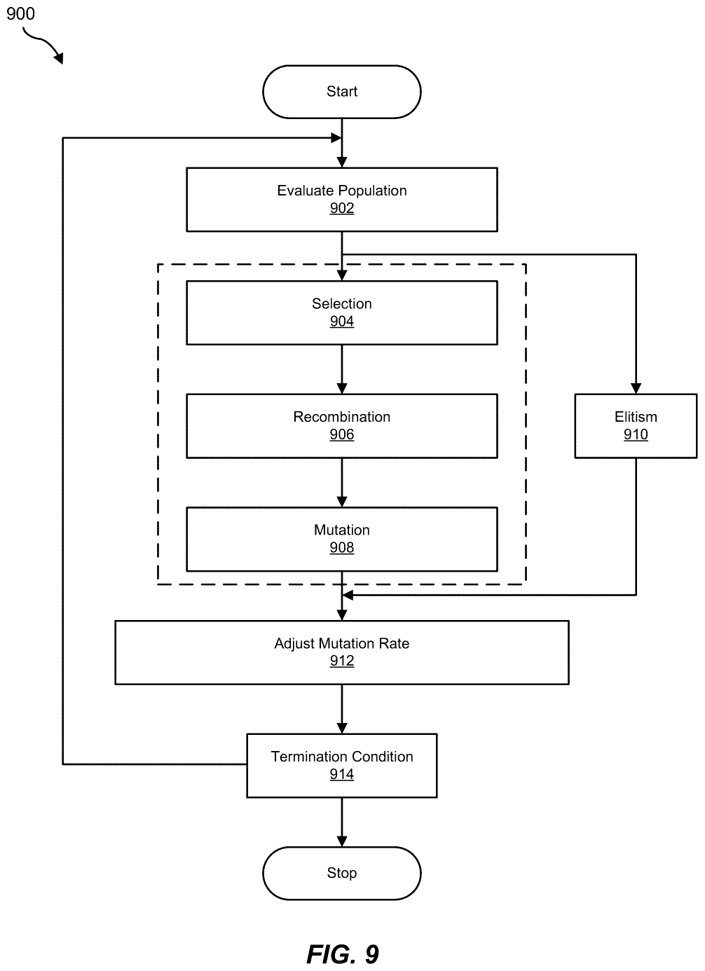

As an alternative or implementation-focused example, FIG. 9 illustrates an operational flow 900 of an evolutionary algorithm used in antenna design, starting with the evaluation of an initial population of antenna geometries at step 902. Following this, a selection process (e.g., selection 904) identifies promising candidates, which are then recombined (e.g., recombination 906) and mutated (e.g., mutation 908) to explore the design space. An elitism strategy (e.g., elitism 910) is incorporated to retain top-performing designs. The mutation rate is adaptively adjusted (e.g., adjust mutation rate 912) to balance exploration and exploitation within the design space. The process iterates until termination criteria (e.g., termination condition 914) are met, concluding with the output of an optimized antenna geometry.

The process may be entirely specification driven with the only input provided by a user being design specifications and supplementary data (e.g., substrate parameters, design constraints such as the maximum allowed antenna size, etc.). In some examples, design specifications may be formulated for antenna reflection characteristics. Given a target of operating frequency bands [f_{1.1}f_{1.2}], . . . , [f_{K.1}f_{K.2}], where K is the number of bands, the objective may be to find antenna geometry for which the maximum in-band reflection level does not exceed −10 dB. Formally, the problem may be formulated as

$$\\ {x}^{{}_{} *} = arg {min}_{x ∈ X} U ( x )$$

where x* is the optimum design to be identified. It may be helpful to recall that x is a vector of all adjustable parameters, X is the parameter space determined by the lower/upper bounds on the antenna variables, and U is the minimax objective function defined as

$$\\ U ( x ) = {max}_{f ∈ F} \{ \vert {S}_{11} ( x , f ) \vert \}$$

where F=[f_{1.1}f_{1.2}]∪[f_{2.1}f_{2.2}]∪ . . . ∪[f_{K.1}f_{K.2}] and ∪ denotes set-theory summation.

One of the fundamental advantages of the parameterization introduced and described herein is that the vector x determines—at the same time—the antenna topology and specific dimensions. This means that the same set of parameters can be processed using global search methods (to determine the optimum antenna topology) and local algorithms (to fine-tune the antenna performance).

One of the algorithmic tools employed to perform antenna structure development using the parameterization described herein is a floating-point evolutionary algorithm with elitism and adaptive adjustment of the mutation rate.

The algorithm may include a variety of components, as will be described in greater detail below. For example, the algorithm may include a generational model where a new population entirely replaces a previous population. In some examples, a population size may be set to N.

The algorithm may also include binary tournament selection, a genetic algorithm process where two individuals are randomly chosen from the population and the one with the better fitness is selected for crossover. The algorithm may also include an Elitism scheme with a single best individual inserted to the next population (with by-passing recombination operators).

The algorithm may also include a mixture of intermediate and arithmetic crossover (with equal probabilities. For example, let x=[x₁ . . . xₙ]^{T} and y=[y₁ . . . yₙ]^{T} be the parent individuals and z=[z₁ . . . zₙ]^{T} be an offspring. The intermediate crossover may produce z so that zᵢ=axᵢ+(1−a)yᵢ with 0≤a≤1 (a selected randomly); the arithmetic crossover yield z=ax+(1−a)y with 0≤a≤1 (a selected randomly). The crossover probability may be pₘ=0.8.

The algorithm may also include random mutation with non-uniform probability distribution. It may be applied individually to each parameter vector component so that xᵢ→xᵢ′=xᵢ+Δxᵢ, where Δxᵢ is a random deviation defined as

$$\\ Δ {x}_{i} = \{ \begin{matrix}( {x}_{i . max} - {x}_{i} ) \cdot {( 2 ( r - 0.5 ) )}^{β} & if r > 0.5 \\ ( {x}_{i . min} - {x}_{i} ) \cdot {( 2 ( 0.5 - r ) )}^{β} & otherwise\end{matrix}$$

where r∈[0-1] is a random number and, in some examples, β=3.

In some examples, the algorithm may be terminated based on exceeding a computational budget (e.g., a maximum number of iterations denoted as Nᵢ).

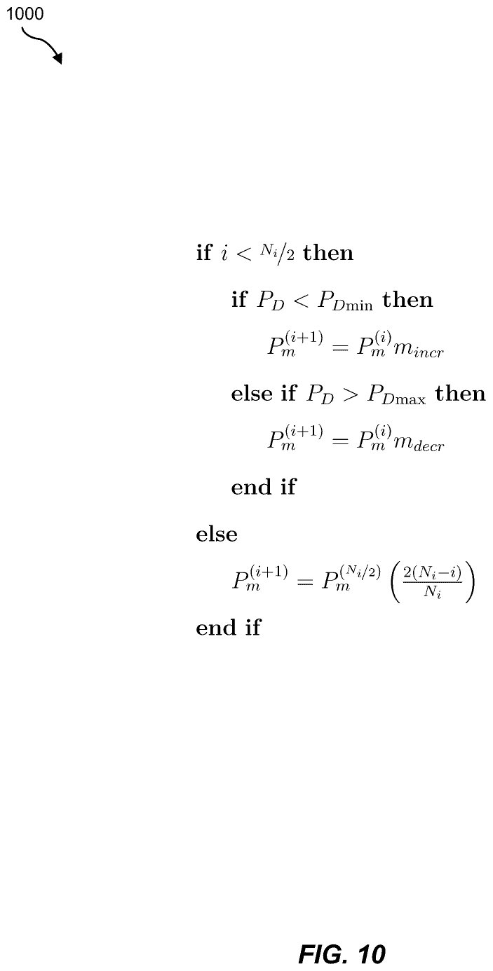

Furthermore, adaptive adjustment of mutation rate pₘ may be implemented as follows. Let P_{D} be a population diversity defined as

$$\\ {P}_{D} = \frac{1}{n} {\sum }_{k = 1}^{n} std ( [ {x}_{1. k} {x}_{2. k} … {x}_{N . k} ] )$$

where x^{j}=[x_{j.1} . . . x_{j.n}]^{T} is j-th member of the population, and x_{j.k} is its k-th entry. Thus, P_{D} is the average standard deviation of the population averaged over all antenna parameters. The mutation rate pₘ⁽ⁱ⁺¹⁾ for iteration i of the algorithm is determined as shown in FIG. 10 (the initial mutation rate pₘ⁽⁰⁾ is set to 0.2.

FIG. 10 shows an algorithm 1000 for determining a mutation rate. Here, we use P_{Dmin}=0.05, P_{Dmax}=0.1, m_{incr}=1.3, and m_{decr}=1.2. The multiplication factors may not be critical due to self-adjustment. The minimum/maximum population diversities are set having in mind that most of antenna parameters are relative (i.e., change between zero and one). In the second half of the search process, mutation probability gradually decreases to zero, which may improve exploitation capability of the algorithm.

In some examples, embodiments of the systems and methods described herein may incorporate local parameter tuning. The purpose of this second optimization stage may be to improve antenna performance (e.g., impedance matching over the target operating bands) through local tuning of antenna parameters. In some examples described herein, implementations may use a trust-region gradient-based algorithm with numerical derivatives, as will be briefly outlined below.

The goal is to again solve the optimization problems described above, with the starting point being the design obtained through global search, which will be denoted as x(0). The algorithm produces a series of approximations x(i), i=0, 1, . . . , of approximations to the optimum design x* using a linear (e.g., first order Taylor) model of antenna responses established at the current iteration point.

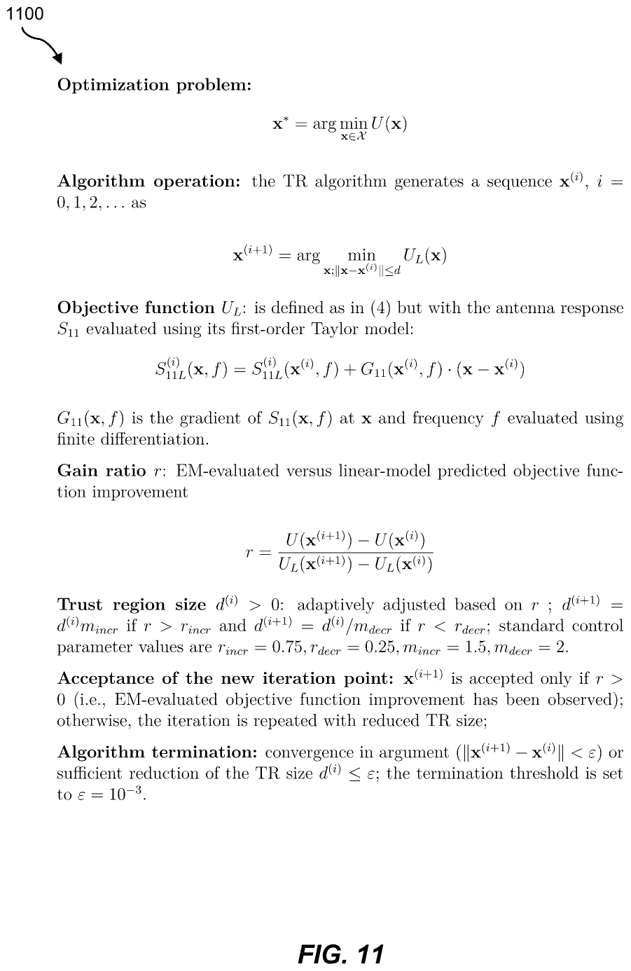

The details of the algorithm can be found in FIG. 11, which provides an outline of a trust-region gradient-based algorithm 1100 with numerical derivatives. As shown therein, the problem is solved using Sequential Quadratic Approximation (SQP) algorithm, which may be implemented as a part of the MATLAB Optimization Toolbox. It may be noted that each iteration of the algorithm requires at least n+1 EM analyses (n being the parameter space dimensionality).

In some implementations, a finite-differentiation-based sensitivity estimation may also be used for parameter pre-screening. The parameters for which sensitivity is zero (e.g., due to a particular antenna building block being inactive) may be excluded from the optimization process, which reduces the overall cost.

It may be reiterated that, due to the assumed antenna parameterization, the same parameter vector x can be employed to realize both the global and local search stage. This is because large-scale adjustments of these parameters directly affect the antenna topology, whereas localized changes only alter antenna responses while keeping the topology intact.

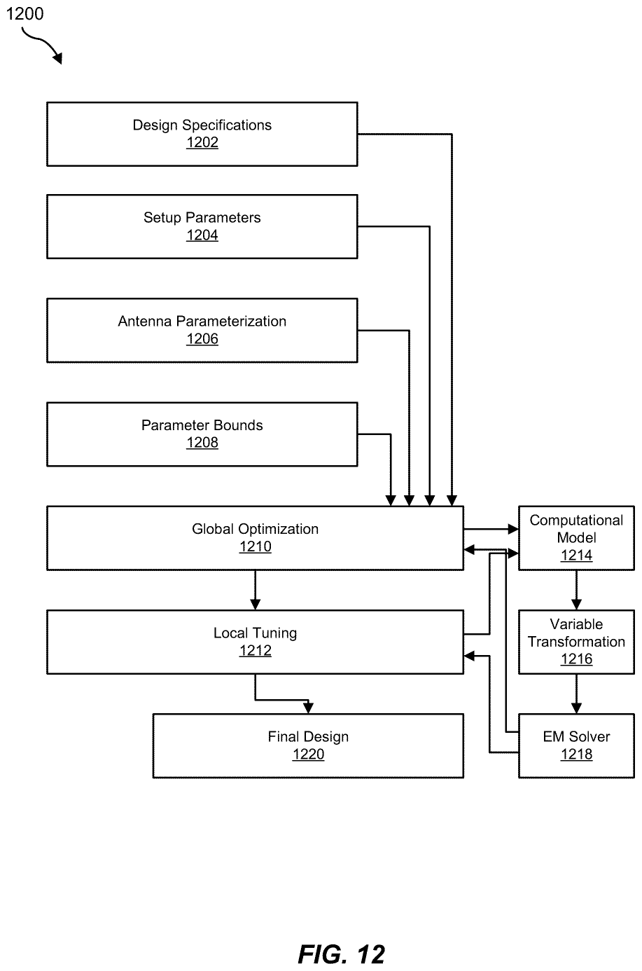

FIG. 12 shows a flow diagram 1200 of an additional implementation of the proposed framework for unsupervised design of planar antennas, and may be executed by one or more of modules 102 described herein. The process is specification-driven and unsupervised in the sense that both antenna topology and its specific dimensions are automatically generated using a two-stage optimization process as described above. The only input information provided by the user are design specifications on antenna reflection, as well as additional requirements for the antenna design (e.g., material parameters of the substrate the antenna is to be implemented on, substrate dimensions or constraints on maximum antenna footprint area, etc.). In some examples, parameterization complexity, i.e., the numbers N_{P} (denoting patches) and N_{H} (denoting holes) of active components may be decided upon beforehand.

Design specifications 1202 in FIG. 12 may refer to an initial set of technical requirements and performance criteria that the antenna must fulfill, such as operational frequency range, desired gain, impedance, radiation pattern, and power capacity. These specifications provide the foundational goals for the antenna design and serve as benchmarks for evaluating the effectiveness of the generated antenna geometries throughout the optimization process. They are essential inputs that drive the subsequent stages of the antenna design, and may be analogous to specifications data 142 described above in relation to FIG. 1 and FIG. 2.

Setup parameters 1204 may encompass the preparatory parameters for the antenna design process, including the selection of substrate materials, which determine the dielectric properties affecting antenna performance. It also includes defining the physical and operational constraints such as size limitations, environmental durability, fabrication techniques, and cost considerations. These parameters establish the feasible design space and critical guidelines for the initial antenna structure, influencing the subsequent stages of parameterization and optimization. These setup parameters may be analogous to requirements data 144 described above in reference to FIG. 1 and FIG. 2.

Antenna parameterization 1206 may represent a process of defining a set of controllable variables that describe the physical attributes of the antenna. This may include geometric dimensions, shapes, and the arrangement of antenna elements, as well as material properties. This step may translate the design specifications into a mathematical model with adjustable parameters, enabling the optimization algorithms to systematically alter and evaluate different antenna configurations to identify the most effective design. In some examples, antenna parameterization 1206 may result in parameterization data 146 described above in reference to FIG. 1 and FIG. 2.

Parameter bounds 1208 may describe limits within which the antenna parameters can vary. It may include minimum and maximum values for each parameter that define the antenna's structure, such as the number of feed points (N_{F}) and the number of patches or slots (N_{H}). These bounds may be helpful for ensuring that the antenna designs generated by the optimization algorithms are both practical and manufacturable, adhering to physical, fabrication, or regulatory constraints. Parameter bounds 1208 may be analogous to bounds data 148 described above in reference to FIG. 1 and FIG. 2.

Global optimization 1210 in FIG. 12 may refer to the use of an algorithm inspired by biological evolution (e.g., an evolutionary algorithm) to explore the antenna design space on a macro scale. It may apply mechanisms like selection, crossover, and mutation to a population of antenna designs to iteratively improve performance. The objective may be to identify the best possible antenna design that meets or exceeds the specified design criteria, while navigating through a diverse set of potential solutions and avoiding local optima. Global optimization 1210 may be analogous to and/or representative of global optimization algorithm 204 described above in reference to FIG. 2.

Local tuning 1212 in FIG. 12 may involve refining the antenna design obtained from the global optimization phase (e.g., global optimization 1210). It may employ a trust-region approach that narrows the search to the vicinity of the current best solution, using gradient-based methods to precisely adjust antenna parameters. This fine-tuning phase may enhance performance characteristics such as bandwidth, efficiency, or gain to meet the exacting specifications of the design requirements. Local tuning 1212 may be analogous and/or similar to local tuning algorithm 206 described above in reference to FIG. 2.

Computational model 1214 includes the theoretical framework and algorithms that simulate the physical phenomena governing antenna behavior, transforming design parameters into predicted performance metrics. Variable transformation 1216 represents the conversion of design parameters into forms suitable for computational analysis, ensuring compatibility between the parameterization used by the optimization algorithms and the computational models. EM Solver 1218 represents an electromagnetic solver, a computational tool that takes transformed variables to calculate the electromagnetic fields, impedances, and radiation patterns, providing a virtual testbed for the antenna's performance against the design specifications.

Final design 1220 represents the culmination of the antenna design process, where the optimized antenna structure is finalized. This design incorporates the most effective geometry and material properties, as determined by the computational modeling and optimization phases, to meet or exceed the initial design specifications. The final design is ready for prototyping or production, and it encapsulates the best solution for the antenna's intended application. Final design 1220 may be analogous to antenna design 208 described above in reference to FIG. 2.

Returning to FIG. 3, at step 330, one or more of the systems described herein may optionally output the design for the antenna architecture. For example, outputting module 108 may, as part of computing device 202 in FIG. 2, output antenna design 208. Outputting module 108 may output antenna design 208 in a variety of contexts. For example, outputting module 108 might generate a detailed report containing all the antenna parameters, performance metrics, and design considerations. Additionally or alternatively, outputting module 108 could create a digital model or CAD file, which could be used for prototyping or manufacturing. In advanced systems, outputting module 108 might even integrate with automated manufacturing tools, like 3D printers, to directly produce a physical model of the designed antenna.

Although not reiterated here, various examples that may demonstrate operation of the proposed unsupervised antenna system are provided in detail in Appendix B to U.S. Provisional Patent Application No. 63/435,123 (“Appendix B”), incorporated by reference above.

As may be clear from the foregoing, embodiments of the systems and methods described herein may transform antenna design by enabling the unsupervised, specification-driven creation of planar antennas. Utilizing a flexible and scalable parameterization approach, embodiments may efficiently generate complex geometries with fewer variables. They may incorporate a nature-inspired algorithm for broad optimization and a gradient-based process for fine-tuning, substantially reducing the need for human expertise and computational resources. This autonomous operation accelerates the design process, allowing for exploration of a wide array of unconventional antenna topologies, catering to diverse industrial needs.

The following example embodiments are also included in this disclosure:

Example 1: A computer-implemented method comprising (1) receiving (A) a set of design specifications associated with an antenna performance characteristic, (B) a set of requirements for an antenna architecture, (C) a parameterization that describes parameters of an antenna structure, and (D) a set of bounds for the parameterization, and (2) determining, based on the set of design specifications, the set of requirements, the parameterization, and the set of bounds, and in accordance with a global optimization algorithm and a local tuning algorithm, a design for the antenna architecture.

Example 2: The computer-implemented method of example 1, wherein the method operates unsupervised without human interaction.

Example 3: The computer-implemented method of any of examples 1-2, wherein determining the design for the antenna architecture comprises (1) automatically generating a plurality of antenna geometries based on the design specifications using a nature-inspired algorithm within a scalable antenna parameterization framework, (2) selecting an initial antenna geometry from the plurality of generated geometries, (3) refining the selected antenna geometry by applying a gradient-based optimization procedure to fine-tune antenna dimensions, and (4) outputting the refined antenna geometry.

Example 4: The computer-implemented method of example 3, wherein automatically generating the plurality of antenna geometries comprises (1) initializing a population of antenna designs within the scalable antenna parameterization framework based on the set of design specifications, (2) executing an iterative process for evolving the antenna designs using the nature-inspired algorithm, wherein the iterative process comprises (A) evaluating the performance of each antenna design against the set of design specifications, (B) selecting a superior antenna design based on a performance evaluation, (C) generating a new antenna designs by applying variation operators within the bounds of the parameterization, and (3) repeating the iterative process until a predetermined criterion is met, resulting in a diverse set of optimized antenna geometries for selection.

Example 5: The computer-implemented method of any of examples 3-4, further comprising adjusting the scalable antenna parameterization framework to accommodate multiple levels of structural complexity in antenna designs.

Example 6: The computer-implemented method of any of examples 3-5, wherein the scalable antenna parameterization framework comprises (1) defining a set of geometric parameters for the antenna structure, the set of geometric parameters comprising dimensions, shapes, and configurations of antenna elements, (2) establishing a range for each geometric parameter within the set of bounds for the parameterization, and (3) dynamically adjusting the set of geometric parameters.

Example 7: The computer-implemented method of example 6, further comprising Incorporating into the scalable antenna parameterization framework both continuous and discrete parameters for the antenna structure.

Example 8: The computer-implemented method of any of examples 3-7, wherein the nature-inspired algorithm comprises an algorithm that models natural processes to optimize antenna geometries, comprising one or more of (1) a genetic algorithm, (2) a particle swarm optimization, or (3) an ant colony optimization.

Example 9: The computer-implemented method of example 8, further comprising implementing at least one algorithmic enhancement to the nature-inspired algorithm, the at least one algorithmic enhancement comprising at least one of (1) adaptive mutation rates in genetic algorithms, (2) targeted selection criteria based on desired antenna performance characteristics, or (3) dynamic population management strategies.

Example 10: The computer-implemented method of any of examples 3-9, further comprising employing a multi-objective optimization approach within the nature-inspired algorithm, wherein the multi-objective optimization simultaneously targets multiple antenna performance characteristics.

Example 11: The computer-implemented method of example 10, wherein the multiple antenna performance characteristics comprise gain, bandwidth, and radiation pattern.

Example 12: The computer-implemented method of any of examples 3-11, wherein determining the design for the antenna architecture further comprises adapting the design for the antenna based on physical and/or electrical properties unique to an antenna type.

Example 13: The computer-implemented method of example 12, wherein the antenna type comprises a single-layer microstrip antenna.

Example 14: A system comprising (1) a receiving module, stored in memory, that receives (A) a set of design specifications associated with an antenna performance characteristic, (B) a set of requirements for an antenna architecture, (C) a parameterization that describes parameters of an antenna structure, and (D) a set of bounds for the parameterization, and (2) a determining module, stored in memory, that determines, based on the set of design specifications, the set of requirements, the parameterization, and the set of bounds, and in accordance with a global optimization algorithm and a local tuning algorithm, a design for the antenna architecture, and (3) at least one physical processor that executes the receiving module and the determining module.

Example 15: The system of example 14, wherein the determining module determines the design for the antenna architecture by (1) automatically generating a plurality of antenna geometries based on the design specifications using a nature-inspired algorithm within a scalable antenna parameterization framework, (2) selecting an initial antenna geometry from the plurality of generated geometries, (3) refining the selected antenna geometry by applying a gradient-based optimization procedure to fine-tune antenna dimensions, and (4) outputting the refined antenna geometry.

Example 16: The system of example 15, wherein the determining module automatically generates the plurality of antenna geometries by (1) initializing a population of antenna designs within the scalable antenna parameterization framework based on the set of design specifications, (2) executing an iterative process for evolving the antenna designs using the nature-inspired algorithm, wherein the iterative process comprises (A) evaluating the performance of each antenna design against the set of design specifications, (B) selecting a superior antenna design based on a performance evaluation, (C) generating a new antenna designs by applying variation operators within the bounds of the parameterization, and (3) repeating the iterative process until a predetermined criterion is met, resulting in a diverse set of optimized antenna geometries for selection.

Example 17: The system of any of examples 15-16, wherein the determining module automatically generates the plurality of antenna geometries based on the design specifications using the nature-inspired algorithm within the scalable antenna parameterization framework by (1) defining a set of geometric parameters for the antenna structure, the set of geometric parameters comprising dimensions, shapes, and configurations of antenna elements, (2) establishing a range for each geometric parameter within the set of bounds for the parameterization, and (3) dynamically adjusting the set of geometric parameters.

Example 18: The system of any of examples 15-17, wherein the determining module employs a multi-objective optimization approach within the nature-inspired algorithm, wherein the multi-objective optimization simultaneously targets multiple antenna performance characteristics.

Example 19: A non-transitory computer-readable medium comprising one or more computer-executable instructions that, when executed by at least one processor of a computing device, cause the computing device to (1) receive (A) a set of design specifications associated with an antenna performance characteristic, (B) a set of requirements for an antenna architecture, (C) a parameterization that describes parameters of an antenna structure, and (D) a set of bounds for the parameterization, and (2) determine, based on the set of design specifications, the set of requirements, the parameterization, and the set of bounds, and in accordance with a global optimization algorithm and a local tuning algorithm, a design for the antenna architecture.

Example 20: The non-transitory computer-readable medium of example 19, wherein the computer-executable instructions, when executed by the at least one processor of the computing device cause the computing device to determine the design for the antenna architecture by (1) automatically generating a plurality of antenna geometries based on the design specifications using a nature-inspired algorithm within a scalable antenna parameterization framework, (2) selecting an initial antenna geometry from the plurality of generated geometries, (3) refining the selected antenna geometry by applying a gradient-based optimization procedure to fine-tune antenna dimensions, and (4) outputting the refined antenna geometry.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

In some examples, one or more of the process parameters, algorithms, operations, or steps described herein may be performed by a computer-implemented system that may include one or more modules, stored in a physical memory, and configured to perform one or more tasks when executed by at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive antenna data (e.g., parameters, specifications, etc.) to be transformed, transform the antenna data, output a result of the transformation to design an antenna, use the result of the transformation to design an antenna, and store the result of the transformation to improve the antenna design functions described herein. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A computer-implemented method comprising:
receiving:
a set of design specifications associated with an antenna performance characteristic;
a set of requirements for an antenna architecture;
a parameterization that describes parameters of an antenna structure; and
a set of bounds for the parameterization; and
determining, based on the set of design specifications, the set of requirements, the parameterization, and the set of bounds, and in accordance with a global optimization algorithm and a local tuning algorithm, a design for the antenna architecture.

2. The computer-implemented method of claim 1, wherein the method operates unsupervised without human interaction.

3. The computer-implemented method of claim 1, wherein determining the design for the antenna architecture comprises:
automatically generating a plurality of antenna geometries based on the design specifications using a nature-inspired algorithm within a scalable antenna parameterization framework;
selecting an initial antenna geometry from the plurality of generated geometries;
refining the selected antenna geometry by applying a gradient-based optimization procedure to fine-tune antenna dimensions; and
outputting the refined antenna geometry.

4. The computer-implemented method of claim 3, wherein automatically generating the plurality of antenna geometries comprises:
initializing a population of antenna designs within the scalable antenna parameterization framework based on the set of design specifications;
executing an iterative process for evolving the antenna designs using the nature-inspired algorithm, wherein the iterative process comprises:
evaluating the performance of each antenna design against the set of design specifications;
selecting a superior antenna design based on a performance evaluation;
generating a new antenna designs by applying variation operators within the bounds of the parameterization; and
repeating the iterative process until a predetermined criterion is met, resulting in a diverse set of optimized antenna geometries for selection.

5. The computer-implemented method of claim 3, further comprising adjusting the scalable antenna parameterization framework to accommodate multiple levels of structural complexity in antenna designs.

6. The computer-implemented method of claim 3, wherein the scalable antenna parameterization framework comprises:
defining a set of geometric parameters for the antenna structure, the set of geometric parameters comprising dimensions, shapes, and configurations of antenna elements;
establishing a range for each geometric parameter within the set of bounds for the parameterization; and
dynamically adjusting the set of geometric parameters.

7. The computer-implemented method of claim 6, further comprising Incorporating into the scalable antenna parameterization framework both continuous and discrete parameters for the antenna structure.

8. The computer-implemented method of claim 3, wherein the nature-inspired algorithm comprises an algorithm that models natural processes to optimize antenna geometries, comprising one or more of:
a genetic algorithm;
a particle swarm optimization; or
an ant colony optimization.

9. The computer-implemented method of claim 8, further comprising implementing at least one algorithmic enhancement to the nature-inspired algorithm, the at least one algorithmic enhancement comprising at least one of:
adaptive mutation rates in genetic algorithms;
targeted selection criteria based on desired antenna performance characteristics; or
dynamic population management strategies.

10. The computer-implemented method of claim 3, further comprising employing a multi-objective optimization approach within the nature-inspired algorithm, wherein the multi-objective optimization simultaneously targets multiple antenna performance characteristics.

11. The computer-implemented method of claim 10, wherein the multiple antenna performance characteristics comprise gain; bandwidth; and radiation pattern.

12. The computer-implemented method of claim 3, wherein determining the design for the antenna architecture further comprises adapting the design for the antenna based on physical and/or electrical properties unique to an antenna type.

13. The computer-implemented method of claim 12, wherein the antenna type comprises a single-layer microstrip antenna.

14. A system comprising:
a receiving module, stored in memory, that receives:
a set of design specifications associated with an antenna performance characteristic;
a set of requirements for an antenna architecture;
a parameterization that describes parameters of an antenna structure; and
a set of bounds for the parameterization; and
a determining module, stored in memory, that determines, based on the set of design specifications, the set of requirements, the parameterization, and the set of bounds, and in accordance with a global optimization algorithm and a local tuning algorithm, a design for the antenna architecture; and
at least one physical processor that executes the receiving module and the determining module.

15. The system of claim 14, wherein the determining module determines the design for the antenna architecture by:
automatically generating a plurality of antenna geometries based on the design specifications using a nature-inspired algorithm within a scalable antenna parameterization framework;
selecting an initial antenna geometry from the plurality of generated geometries;
refining the selected antenna geometry by applying a gradient-based optimization procedure to fine-tune antenna dimensions; and
outputting the refined antenna geometry.

16. The system of claim 15, wherein the determining module automatically generates the plurality of antenna geometries by:
initializing a population of antenna designs within the scalable antenna parameterization framework based on the set of design specifications;
executing an iterative process for evolving the antenna designs using the nature-inspired algorithm, wherein the iterative process comprises:
evaluating the performance of each antenna design against the set of design specifications;
selecting a superior antenna design based on a performance evaluation;
generating a new antenna designs by applying variation operators within the bounds of the parameterization; and
repeating the iterative process until a predetermined criterion is met, resulting in a diverse set of optimized antenna geometries for selection.

17. The system of claim 15, wherein the determining module automatically generates the plurality of antenna geometries based on the design specifications using the nature-inspired algorithm within the scalable antenna parameterization framework by:
defining a set of geometric parameters for the antenna structure, the set of geometric parameters comprising dimensions, shapes, and configurations of antenna elements;
establishing a range for each geometric parameter within the set of bounds for the parameterization; and
dynamically adjusting the set of geometric parameters.

18. The system of claim 15, wherein the determining module employs a multi-objective optimization approach within the nature-inspired algorithm, wherein the multi-objective optimization simultaneously targets multiple antenna performance characteristics.

19. A non-transitory computer-readable medium comprising one or more computer-executable instructions that, when executed by at least one processor of a computing device, cause the computing device to:
receive:
a set of design specifications associated with an antenna performance characteristic;
a set of requirements for an antenna architecture;
a parameterization that describes parameters of an antenna structure; and
a set of bounds for the parameterization; and
determine, based on the set of design specifications, the set of requirements, the parameterization, and the set of bounds, and in accordance with a global optimization algorithm and a local tuning algorithm, a design for the antenna architecture.

20. The non-transitory computer-readable medium of claim 19, wherein the computer-executable instructions, when executed by the at least one processor of the computing device cause the computing device to determine the design for the antenna architecture by:
automatically generating a plurality of antenna geometries based on the design specifications using a nature-inspired algorithm within a scalable antenna parameterization framework;
selecting an initial antenna geometry from the plurality of generated geometries;
refining the selected antenna geometry by applying a gradient-based optimization procedure to fine-tune antenna dimensions; and
outputting the refined antenna geometry.
